(19) United States
(12) Patent Application Publication
(10) Pub. No.: US 2003/0111812 A1
(43) Pub. Date: Jun. 19, 2003

(54) Adjustable suspension assembly control arms

(76) Inventors: Robert P. Carlstedt, Rochester Hills, MI (US); James B. Chamberlin, Charlotte, NC (US); Ragnar Ledesma, Sterling Heights, MI (US); Nancy L. Saxon, Oakland Tonwship, MI (US); Dennis A. Kramer, Troy, MI (US); Doyle R. Downey, Beverly Hills, MI (US); Joseph Cubalchini JR., St. Charles, IL (US); Monte G. Williams, Royal Oak, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/025,230

(22) Filed: Dec. 19, 2001

(51) Int. Cl. B60G 1/00

(52) U.S. Cl. 280/124.16; 280/124.157

(57) ABSTRACT

A suspension assembly for a vehicle is provided that includes a frame supporting upper and lower control arms in spaced relation to one another that are pivotally connected to the frame. A steering knuckle is supported between the control arms and supports a wheel. The orientation of the knuckle defines the wheel attitude, which includes caster, camber, toe, and track. The knuckle is rotated about its axis in response to mechanical inputs from a steering wheel. First and second actuators may be supported on one of the control arms and connected to a portion of the knuckle. A third actuator may be supported on the other control arm and connected to another portion of the knuckle. At least one sensor detects vehicle ride conditions such as braking, vehicle yaw, and steering position. A controller is connected to the sensors and the actuators to command the actuators to adjust at least one of the caster, camber, toe, and track in response to the vehicle ride conditions.

### BACKGROUND OF THE INVENTION

This invention relates to an adjustable suspension for use with convention mechanical steering, and more particularly, the invention relates to an adjustable suspension on upper and lower control arms that adjusts the wheel attitude.

Despite technological advances in the automobile industry, modern vehicles continue to rely upon mechanical steering systems to steer the vehicle. That is, an input from a steering wheel is transmitted to the wheels through mechanical linkages and gears to steer the wheels. Entirely electric steering has been proposed in which there are no mechanical linkages-just actuators commanded by an electronic input. However, these systems present potential reliability problems in which steering control may be lost in the event of a loss of power to the system.

Some hybrid mechanical and electric systems have been proposed in which the attitude of the wheel is adjusted in response to vehicle handling conditions. The vehicle is mechanically steered, and the wheel attitude is adjusted to a desired position to improve vehicle stability and handling performance. Wheel attitude may include wheel caster, camber, toe, and track. However, the proposed systems have typically involved numerous linkages which may be difficult to package. Some systems have been developed for MacPherson strut arrangements, but may not be suitable for upper and lower control arm suspension arrangements. All of the systems proposed have been very specialized in that they have been designed to address only one or two types of wheel attitude adjustment. Therefore, what is needed is an adjustment system for an upper and lower control arm suspension arrangement that may be easily packaged and adjust more aspects of wheel attitude.

### SUMMARY OF THE INVENTION AND ADVANTAGES

The present invention provides a suspension assembly for a vehicle that includes a frame supporting upper and lower control arms in spaced relation to one another that are pivotally connected to the frame. A steering knuckle is supported between the control arms and supports a wheel. The orientation of the knuckle defines the wheel attitude, which includes caster, camber, toe, and track. The knuckle is rotated about its axis in response to mechanical inputs from a steering wheel. First and second actuators may be supported on one of the control arms and connected to a portion of the knuckle. A third actuator may be supported on the other control arm and connected to another portion of the knuckle. At least one sensor detects vehicle ride conditions such as braking, vehicle yaw, and steering position. A controller is connected to the sensors and the actuators to command the actuators to adjust at least one of the caster, camber, toe, and track in response to the vehicle ride conditions.

Accordingly, the above present invention provides an adjustment system for an upper and lower control arm suspension arrangement that may be easily packaged and adjust more aspects of wheel attitude.

### BRIEF DESCRIPTION OF THE DRAWINGS

Other advantages of the present invention can be understood by reference to the following detailed description when considered in connection with the accompanying drawings wherein:

FIG. 1 is a front schematic view of the present invention adjustable steering assembly;

FIG. 2 is a top schematic view of steering assembly shown in FIG. 1;

FIG. 3 is a top view of a lower control arm with first and second actuators;

FIG. 4 is a front view of an upper control arm with a third actuator; and

FIG. 5 is a schematic of a control system for the present invention adjustable steering assembly.

### DETAILED DESCRIPTION OF THE PREFERRED EMBODIMENT

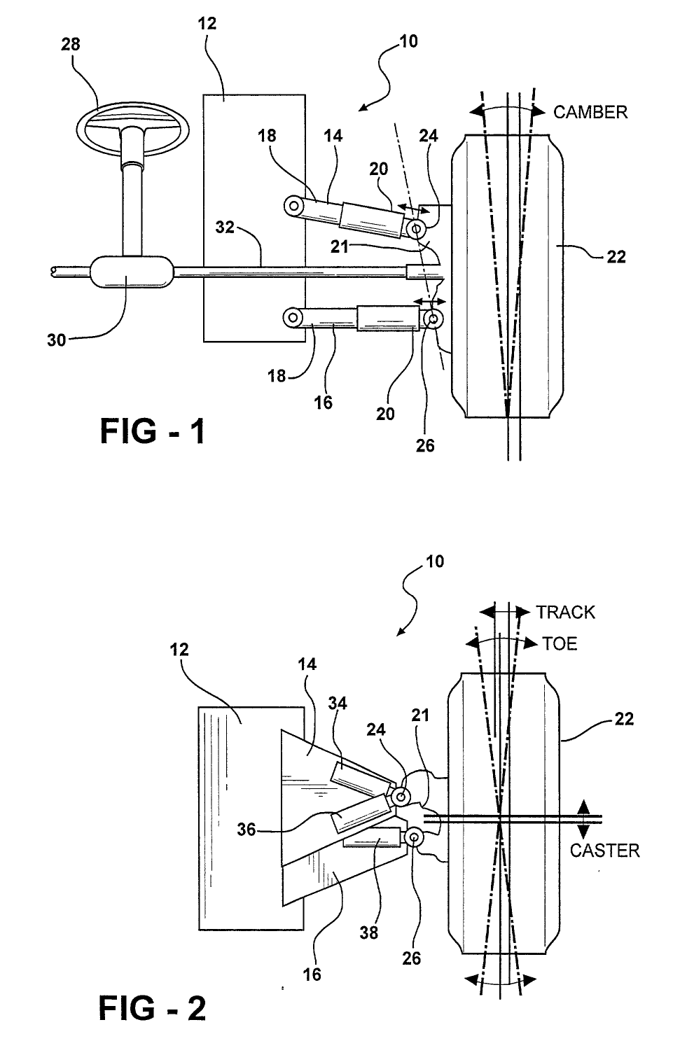

An adjustable suspension system 10 is shown in FIGS. 1 and 2. The suspension 10 is of the type that includes upper 18 and lower 16 control arms. A first portion 18 of each of the upper 16 and lower 18 control arms is pivotally connected to a vehicle frame 12. Only one side of the vehicle's front suspension is shown. A second portion 20 of the arms 16 and 18 support a steering knuckle 21 by first 24 and second 26 connections, respectively. The knuckle 21 supports a wheel 22 for rotation about an axis A. The orientation of the axis A defines wheel attitude such as camber and caster, as seen in FIGS. 1 and 2 respectively.

A steering wheel 28 is mechanically connected to the knuckle 21 though a gearbox 30, such as a rack and pinion, and a linkage 32, as is well know in the art. The wheels 22 are turned when the steering wheel 28 rotates the knuckle 21 about axis A through the gearbox 30 and linkage 32. The connections 24 and 26 are typically ball joints that permit the knuckle 21 to rotate relative to the arms 14 and 16 during upward and downward motion of the wheel 22 as the knuckle is rotated about its axis A.

The wheel position that results from the mechanical input from the steering wheel may not provide a desirable wheel attitude. For example, during a sharp, fast turn a greater wheel track may be desired in which the opposing wheels are spaced farther apart to provide increase stability. Similarly, a particular caster, camber, or toe may be desirable for a particular vehicle ride condition. To provide more desirable vehicle handling, it is preferable to adjust several different aspects of wheel attitude simultaneously.

The present invention provides at least three actuators that are connected to the knuckle 21 to adjust multiple aspects of wheel attitude. The actuators used may be hydraulic, pneumatic, electric, or any other suitable type of actuator. Referring to FIG. 2, first 34 and second 36 actuators are arranged on the upper control arm 14 generally coplanar with one another. The actuators 34 and 36 are generally parallel with the upper control arm 14 for improved packaging in a conventional upper/lower control arm suspension arrangement. The actuators 34 and 36 are arranged transverse to one another and together provide the first connection 24. In this manner, the actuators 34 and 36 may move the first connection 24 forward, rearward, inward and/or outward. One actuator may extend and another may retract simultaneously to move the connection 24 forward or rearward. Both actuators 34 and 36 may extend and retract the same amount simultaneously to move the connection 24 inward or outward.

The lower control arm 16 includes a third actuator 38 that provides the second connection 26 to move the second connection 26 inward and/or outward. The first 34, second 36, and third 38 actuators may move the connections 24 and 26, and thus the knuckle 21, in any desired orientation to effect the desired wheel attitudes.

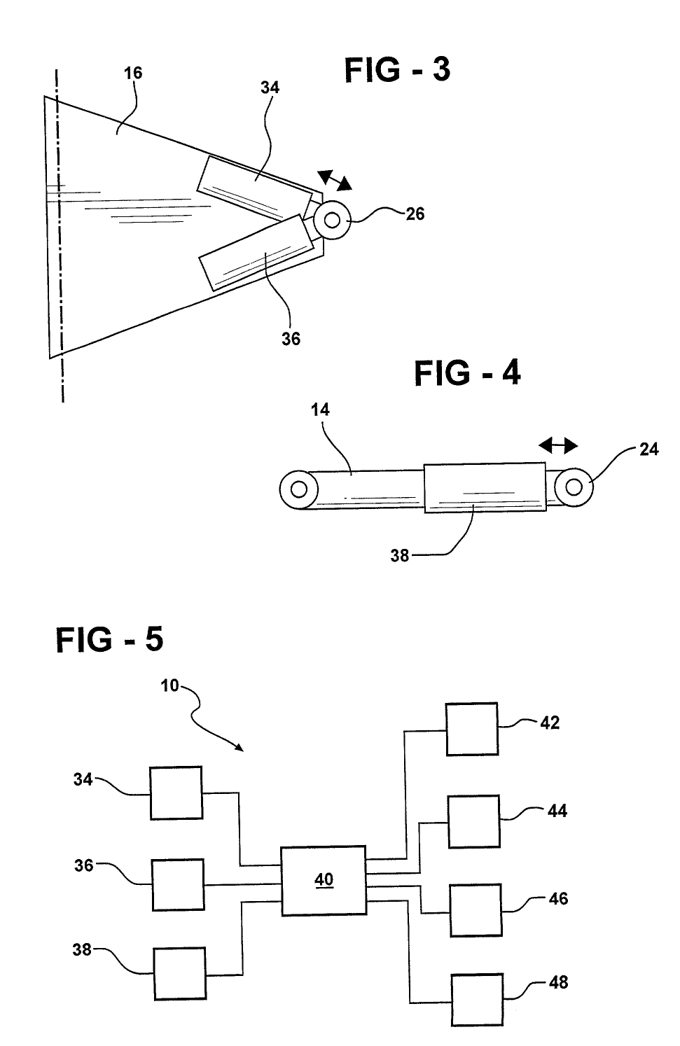

The first 34 and second 36 actuators may be arranged on a lower control arm 16, as shown in FIG. 3. Similarly, the third actuator 38 may be arranged on the upper control arm 14, as shown in FIG. 4.

A control system for the adjustable suspension system 10 is schematically shown in FIG. 5. A controller 40 may be connected to the first 34, second 36, and third 38 actuators for commanding the actuators to move the knuckle 21 to a desired orientation in response to vehicle handling conditions. That is, the controller 40 determines a desired wheel attitude to improve vehicle stability and handling in response to sensed vehicle conditions. To this end, sensors such as a steering linkage position sensor 42, a braking from an ABS 44, vehicle yaw 46, or any other useful information from a sensor 48 may be processed by the controller 40 to determine a desired wheel attitude.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

What is claimed is:

1. A suspension assembly for a vehicle comprising:
a frame;
first and second control arms in spaced relation to one another, said control arms having first and second opposing portions with said first portions pivotally connected to said frame;
a knuckle supported by said second portion of said first control arm at a first connection and said second portion of said second control arm at a second connection, said connections defining camber, caster, toe, and track;
first and second actuators in connection with said first control arm and moving said first connection relative to said frame;
a third actuator in connection with said second control arm and moving said second connection relative to said frame;
a sensor detecting vehicle ride conditions; and
a controller connected to said sensor and said actuators commanding said actuators to adjust at least one of said caster, camber, toe, and track in response to said vehicle ride conditions.

2. The assembly according to claim 1, wherein said first control arm is an upper control arm and said second control arm is a lower control arm.

3. The assembly according to claim 1, wherein said first control arm is a lower control arm and said second control arm is an upper control arm.

4. The assembly according to claim 1, further including a steering linkage mechanically connected to said knuckle with a steering wheel mechanically connected to said steering linkage for rotating said knuckle about an axis defined by said connections by manipulating said steering linkage.

5. The assembly according to claim 4, wherein said sensor includes a steering linkage position sensor sensing the position of said steering linkage.

6. The assembly according to claim 1, wherein said sensor includes a braking sensor in an anti-lock braking system.

7. The assembly according to claim 1, wherein said sensor includes a vehicle yaw sensor.

8. The assembly according to claim 1, wherein said first and second actuators are generally coplanar.

9. The assembly according to claim 8, wherein said actuators are generally parallel with said control arms.

10. The assembly according to claim 1, wherein said connections are provided by ball joints with said actuators connected to said ball joints.

11. The assembly according to claim 1, wherein said actuators are supported on said control arms.

12. A method of adjusting a suspension assembly comprising the steps of:
a) providing a mechanical input from a steering wheel to spaced apart wheels;
b) turning the wheels in response to the mechanical input;
c) detecting vehicle ride conditions;
d) manipulating first, second, and third actuators at each of the wheels in response to the vehicle ride conditions; and
e) adjusting the attitude of the wheels with the actuators to a desired position.

13. The method according to claim 12, wherein step c) includes detecting vehicle yaw.

14. The method according to claim 12, wherein step c) includes detecting a steering wheel position.

15. The method according to claim 12, wherein step c) includes detecting a braking signal.

16. The method according to claim 12, wherein step e) includes adjusting caster.

17. The method according to claim 12, wherein step e) includes adjusting camber.

18. The method according to claim 12, wherein step e) includes adjusting toe.

19. The method according to claim 12, wherein step e) includes adjusting track.
